(19) United States
(12) Patent Application Publication
(10) Pub. No.: US 2015/0364728 A1
(43) Pub. Date: Dec. 17, 2015

(54) BUTTON CELL, IN PARTICULAR FOR A TYRE PRESSURE SENSOR

(71) Applicant: ALLIGATOR VENTILFABRIK GMBH, Giengen (FR)

(72) Inventor: Christian Markert, Herbrechtingen (DE)

(73) Assignee: Alligator Ventilgabrik GmbH, Giengen (DE)

(21) Appl. No.: 14/763,386

(22) PCT Filed: Jan. 28, 2014
(86) PCT No.: PCT/EP2014/051662

§ 371 Date: Jul. 24, 2015

(30) Foreign Application Priority Data
Jan. 28, 2013 (DE) 10 2013 001 371.2

(51) Int. Cl. H01M 2/02; B60C 23/04

(52) U.S. Cl. CPC H01M 2/0222; B60C 23/04; H01M 2/026; H01M 2/0277; H01M 2220/30

(57) ABSTRACT

The invention concerns a button cell, particularly for a tire pressure sensor, with a first electric pole formed by a first front side and a second electric pole (4) formed by a second front side opposite to the first front side;
with a first contact tab mounted on the first front side, which includes a substantially flat extension inside the plane of the first front side, or with a first contact tab formed by the first front side;
with a second contact tab mounted on the second front side, which extends from the plane of the second front side at an angle substantially up to the plane of the first front side;
with an insulation layer mounted on the button cell, at least in the region of the first and second contact tabs or over the external periphery of the button cell.

The invention is characterised in that the insulation layer includes a plurality of openings, which traverse the insulation layer completely and which are distributed over the surface of the insulation layer.

The present invention relates to a button cell, particularly for a tire pressure sensor and a tire pressure sensor with such a button cell.

Button cells are always used for the electrical power supply when only a small receiving chamber for batteries is available. Button cells have two flat front sides, each of which forms an electrical pole, namely usually the first side a positive pole and the second side a negative pole.

Conventionally, the contacting of a button cell is effected by a first electrical contact which contacts the first front side, and a second electrical contact which contacts the second front side. In this way multiple button cells can also be connected in series with each other, by simply being stacked on top of each other.

When using button cells in tire pressure sensors, as it relates to the present invention particularly, an electrical connection of the cell battery with two poles in a single common plane, usually on a circuit board is required. In practice, the tendency has been to install a contact tab on each of both front sides, in particular to weld it or to glue it, whereas the one contact tab may have a substantially flat shape on the side facing the circuit board and the other contact tab must have an angular shape on the front side of the button cell facing away from the circuit board, since it extends from said front side facing away therefrom, so to say around the external edge of the button cell up into the plane of the circuit board, a plane in which also the first contact tab is situated. Running the second contact tab in the plane of the first contact tab naturally generates the risk of an electrical short-circuit at the external periphery of the button cell since the pole formed by the first, here lower front side usually up to the external periphery of the button cell and from there slightly in the direction of the other pole. To avoid such a short-circuit, it has been decided, Simply to overlay a non-conducting shrink tube over the external periphery of the button cell and thereby to guarantee an insulation between the second contact tab and the external periphery.

Although the form of embodiment aforementioned operates flawlessly first of all, a surprisingly short lifetime of the button cell has been observed in practice when using the button cell in tire pressure sensors, that is to say that the button cell is discharged prematurely and unexpectedly. The cause was not known immediately.

The object of the present invention is to provide a button cell, in particular for a tire pressure sensor with which the lifetime is lengthened with respect to well-known forms of embodiment.

The object of the invention is satisfied with a button cell exhibiting the features of claim 1. The dependent claims illustrate advantageous embodiments as well as a tire pressure sensor according to the invention.

A button cell according to the invention, in particular for a tire pressure sensor, with a first electric pole formed by a first front side and a second electric pole formed by a second front side opposite to the first front side. A first contact tab is mounted on the first front side and a second contact tab is mounted on the second front side. The contact tab on the first front side shows a substantially flat extension inside which plane the first front side also runs. This does not mean obligatorily that the first contact tab is completely even. The connection plane, in which the first contact tab is connected for contacting the button cell, can be situated slightly outside the plane of the first front side.

The second contact tab extends from the plane of the second front side on which it is mounted, up into the contacting plane of the first contact tab, i.e. substantially up into the plane of the first front side. It is thus possible to place both contact tabs for electrical connection of the button cell in a common plane, respectively in two planes close to each other.

Additionally or alternately to the installation of a first contact tab on the first front side of the button cell, the front side itself can form the contact tab. In such a case, the contacting of the button cell involves the front side itself, for example on a corresponding connection of a circuit board.

An insulation layer is mounted on the button cell at least in the region (circumferential section) of the first and of the second contact tabs and in particular over the whole external periphery to prevent the generation of an electrical short-circuit between the external periphery and the second contact tab.

According to the invention, the insulation layer includes now a large number of openings, which traverse the insulation layer completely and which are distributed over the surface of the insulation layer. By way of example, the insulation layer is designed as a netting, in particular as a stretched netting tube, for instance a shrink netting tube.

The invention is based on the perception that with known closed insulation layers, in particular in view of the temperature fluctuations, moisture could reach into the gap between the insulation layer and the external edge of the button cell, which results in a short circuit leading to the unintentional discharge of the button cell. Said moisture could not escape due to the closed surface of the insulation layer. Thanks to the embodiment according to the invention on the contrary, the space between the insulation layer and button cell can be vented, so as to prevent completely the formation of an electrically conductive moisture film or at least to enable rapid drying by discharging the moisture, in case the latter has cropped up.

The first contact tab and/or the second contact tab can also penetrate the insulation layer, for instance through one of the openings provided therein, in particular through a netting mesh. If the contact tab is thereby covered partially by the insulation layer, an additional insulation with respect to the surrounding can be obtained without making the contacts more difficult.

A tire pressure sensor according to the invention includes a housing, a pressure transducer, transmitting electronics as well as a power supply. Pressure transducer, transmitting electronics and/or power supply are advantageously located inside the housing, partially or completely. The invention is however not limited thereto. Other forms of embodiment set forth an assembly of one component or the other on the housing or also outside the housing.

The power supply contains a button cell according to the invention.

In particular if in addition to the power supply, the pressure transducer and the transmitting electronics are located inside the housing and are surrounded by the housing partially or completely, it is of the advantage, when the housing is appropriately filled with a casting compound so as to be sealed except for an opening to guide the surrounding pressure to the pressure transducer. The casting compound can for example be applied over the whole base of the housing.

Thanks to the embodiment according to the invention of the button cell, the second insulator can be angled particularly tight to the external periphery of the button cell and hence the necessary extension of the button cell can be reduced up to the electrical contacting points in particular on a circuit board inside the housing, the circuit board also accommodating the pressure transducer and the transmitting electronics. The consequence is that the housing can be designed smaller and therefore requires less casting compound. The golden rule is that if the housing must be designed longer by two millimetres for instance, five grams of casting compound more are required which leads to significant cost savings with usually large numbers of units of tire pressure sensors manufactured in series.

The button cell can be soldered for instance with both contact tabs on a circuit board inside the housing to which the pressure transducer and the transmitting electronics are contacted.

It is of advantage, when the housing is suitably be connected in an articulated manner to a tire valve or another receptacle to be fixed to a rim of a vehicle tire so that an adaptation of the housing to the side wall is always guaranteed with various rim types.

The invention will now be described by way of example using an embodiment and the figures.

The figures are as follows:

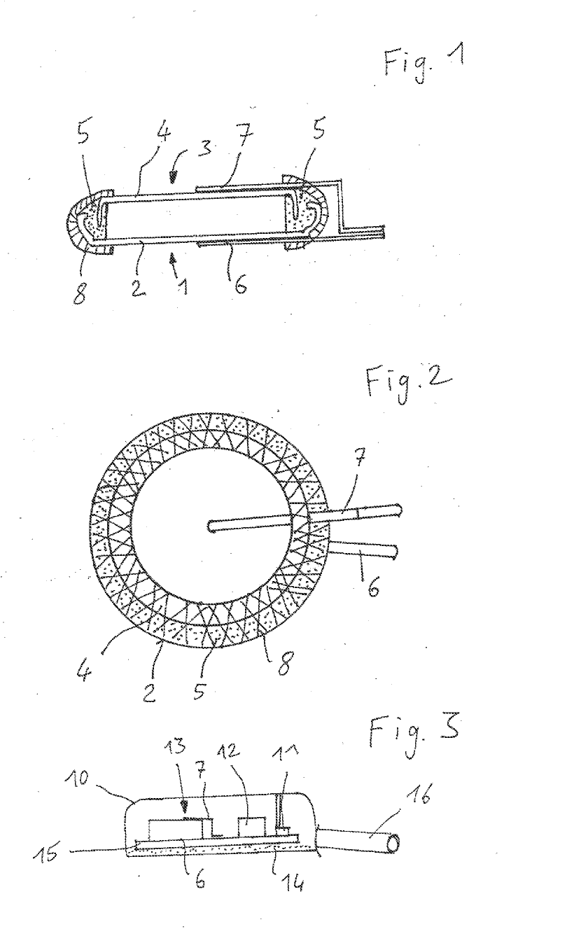

FIG. 1 is a diagrammatical illustration of a sectional view of a button cell according to the invention;

FIG. 2 is a diagrammatical illustration of an elevation view on the button cell on FIG. 1;

FIG. 3 shows a tire pressure sensor with a button cell according to the invention.

In FIG. 1 the inside assembly of a button cell is only roughly indicated. Shown is a first electrically conductive plate forming the first front side 1 of the button cell and hence the first electrical pole 2. Opposite to the first plate is provided a second electrically conductive plate which forms the second front side 3 and therefore the second electrical pole 4.

Both electrically conductive plates and hence the electrical poles 2, 4 are insulated with respect to each other, by means of an insulating mass 5 placed in the region of the external periphery of the button cell therein.

A first contact tab 6 is connected to the first electrical pole 2 in an electrically conductive manner on the first front side 1. The first contact tab 6 extends substantially inside a plane of the first front side 1.

A second contact tab 7, connected to the second electrical pole 4 in an electrically conductive manner, is provided on the second front side 3. Said second contact tab 7 extends substantially inside the plane of the second front side 3 and protrudes over the external periphery of the button cell and is thus angled so that it penetrates the plane substantially of the first front side 1 and runs further. The reason is that the button cell is provided to be contacted on a circuit board (not represented) whereas both contact points of the circuit board are substantially inside a common plane for both electrical poles 2, 4 of the button cell.

As can be seen, the first electrical pole 2 extends from the first front side 1 on the external periphery of the button cell in the direction of the second front side 4. This means that a contact is possible with the first electrical pole 2 on the external periphery of the button cell over a certain height, for instance up to half the height or beyond that. Now to prevent the generation of an electrical short-circuit to the extent that the second contact tab 7 touches the first electrical pole 1 on the external periphery of the button cell, an insulation layer 8 is mounted over the external periphery of the button cell. Said insulation layer 8 extends over the whole height of the button cell and from the outside beyond the external edge of the front sides 1, 3 and both electrical poles 2, 4.

According to the invention, the insulation layer now includes a large number of openings and it is designed as a stretched netting in the illustrated exemplary embodiment.

FIG. 2 again shows the netlike structure of the insulation layer 8 in detail and it is clearly visible that said layer extends from the external periphery of the button cell over the insulating mass 5 up to the second electrical pole 4.

FIG. 2 shows moreover clearly that the first contact tab 6 and the second contact tab 7 are arranged offset to one another in the peripheral direction of the button cell. Both contact tabs 6, 7 moreover penetrate the insulation layer 8.

FIG. 3 represents diagrammatically a tire pressure sensor with a housing 10 which is connected to a tire valve 16 in an articulated manner.

Inside the housing 10 there is provided a circuit board 15, which carries a button cell (power supply 13), transmitting electronics 12 and a pressure transducer 11 and brings them in electrical contact with one another. The button cell is connected to the circuit board 15 via both electrical contact tabs 6, 7. The first contact tab 6 is formed by the lower front side of the button cell in the exemplary embodiment represented here.

The housing 10 is filled with a casting compound 14 so as to seal it against the surrounding with the exception of the air-guiding connection for the pressure transducer 11, in which a membrane could be provided.

Although it is not represented in detail, the button cell is fitted with an insulation layer according to the invention.

1. A button cell, particularly for a tire pressure sensor, with a first electric pole formed by a first front side and a second electric pole formed by a second front side opposite to the first front side;
with a first contact tab mounted on the first front side, which first contact tab includes a substantially flat extension inside the plane of the first front side or with a first contact tab formed by the first front side;
with a second contact tab mounted on the second front side, which second contact tab extends from the plane of the second front side at an angle substantially up to the plane of the first front side;
with an insulation layer mounted on the button cell, at least in the area of the first and second contact tabs or on the external periphery of the button cell;
characterised in that
the insulation layer includes a plurality of openings, which traverse the insulation layer completely and which are distributed over the surface of the insulation layer.

2. A button cell according to claim 1, characterised in that the insulation layer is designed as a netting.

3. A button cell according to claim 1, characterised in that the insulation layer is designed as a netting tube, in particular a shrink netting tube stretched on the button cell.

4. A button cell according to claim 1, characterised in that the first and/or the second contact tab penetrates the insulation layer and is covered partially by the insulation layer.

5. A tire pressure sensor
with a housing;
with a pressure transducer outside, on or inside the housing;
with transmitting electronics on or inside the housing;
with a power supply;
characterised in that
the power supply contains a button cell according to claim 1.

6. A tire pressure sensor according to claim 5, characterised in that the pressure transducer, the transmitting electronics and the button cell are positioned inside the housing and the housing is filled with a casting compound, at least partially, in particular over its whole base.

7. A tire pressure sensor according to claim 5, characterised in that a circuit board is provided in the housing, on which the button cell is soldered, clamped or fastened otherwise with both contact tabs to provide an electrical contact.

8. A tire pressure sensor according to claim 5, characterised in that the housing is connected in an articulated manner to a tire valve.

9. A button cell according to claim 2, characterised in that the insulation layer is designed as a netting tube, in particular a shrink netting tube stretched on the button cell.

10. A button cell according to claim 2, characterised in that the first and/or the second contact tab penetrates the insulation layer and is covered partially by the insulation layer.

11. A button cell according to claim 3, characterised in that the first and/or the second contact tab penetrates the insulation layer and is covered partially by the insulation layer.

12. A tire pressure sensor
with a housing;
with a pressure transducer outside, on or inside the housing;
with transmitting electronics on or inside the housing;
with a power supply;
characterised in that
the power supply contains a button cell according to claim 2.

13. A tire pressure sensor
with a housing;
with a pressure transducer outside, on or inside the housing;
with transmitting electronics on or inside the housing;
with a power supply;
characterised in that
the power supply contains a button cell according to claim 3.

14. A tire pressure sensor
with a housing;
with a pressure transducer outside, on or inside the housing;
with transmitting electronics on or inside the housing;
with a power supply;
characterised in that
the power supply contains a button cell according to claim 4.

15. A tire pressure sensor according to claim 6, characterised in that a circuit board is provided in the housing, on which the button cell is soldered, clamped or fastened otherwise with both contact tabs to provide an electrical contact.

16. A tire pressure sensor according to claim 6, characterised in that the housing is connected in an articulated manner to a tire valve.

17. A tire pressure sensor according to claim 7, characterised in that the housing is connected in an articulated manner to a tire valve.
